(19) United States
(12) Patent Application Publication
(10) Pub. No.: US 2023/0110450 A1
(43) Pub. Date: Apr. 13, 2023

(54) 3D Printing of Thermosetting Polyimlde Copolymers and Composites

(71) Applicant: University of Cincinnati, Cincinnati, OH (US)

(72) Inventors: Jude Onwuegbu Iroh, Mason, OH (US); Xuemei Cui, Cincinnati, OH (US); Shengdong Xiao, Crittenden, KY (US); Ruchinda S. Gooneratne, Cincinnati, OH (US)

(73) Assignee: University of Cincinnati, Cincinnati, OH (US)

(21) Appl. No.: 17/873,856

(22) Filed: Jul. 26, 2022

Related U.S. Application Data
(60) Provisional application No. 63/225,749, filed on Jul. 26, 2021.

(51) Int. Cl. C09D 179/08; C08L 79/08

(52) U.S. Cl. CPC C09D 179/08; C08L 79/08; C08L 2205/025

(57) ABSTRACT

A method of making a three-dimensional object comprising one or more polyimide copolymers, polyimide composites or combinations thereof is provided. The method involves 3D printing a solution comprising polyamic acid (PAA), tetraethyl orthosilicate (TEOS), and a silane selected from the group consisting of aminopropyl trimethoxysilane (APTMS), aminopropyl triethoxysilane (APTES), N-[3-(trimethoxysilyl)propyl]-ethylene diamine (ETDA), and glycidoxypropyl trimethoxysilane (GPTMS) to produce a three-dimensional form, and thermosetting the three-dimensional form.

### CROSS REFERENCE TO RELATED APPLICATIONS

This application claims priority to U.S. Provisional Application Serial No. 63/225,749, filed Jul. 26, 2021, which application is hereby incorporated by reference in its entirety.

### STATEMENT REGARDING FEDERALLY SPONSORED RESEARCH OR DEVELOPMENT

This invention was made with government support under contract FA8649-21-P-0128 awarded by the Air Force Research Laboratory (AFRL). The government has certain rights in the invention.

### TECHNICAL FIELD

The present invention relates to additive manufacturing via 3D printing.

### BACKGROUND OF THE INVENTION

Direct ink writing (DIW) of polyamic acid solution with optimized rheology followed by thermal imidization has been proposed to realize the 3D printing of thermoset polyimide. However, even with very high solid content, neat polyamic acid (PAA) or PAA-CNT/NGS solution ink can only attain limited viscosity and the beads easily collapse after printing out due to the nature of the linear polymer chain. Therefore, a need still exists for a method of successfully 3D printing thermoset polyimide.

### SUMMARY OF THE INVENTION

In one embodiment, the present invention is a novel method of making a three-dimensional object comprising one or more polyimide copolymers, polyimide composites or combinations thereof. The method involves 3D printing a solution comprising polyamic acid (PAA), tetraethyl orthosilicate (TEOS), and a silane selected from the group consisting of aminopropyltrimethoxysilane (APTMS), aminopropyl triethoxysilane (APTES), N-[3-(trimethoxysilyl)propyl]-ethylene diamine (ETDA), and glycidoxypropyl trimethoxysilane (GPTMS) to produce a three-dimensional form, and thermosetting the three-dimensional form.

In one embodiment, the 3D printing of thermosetting polyimide and polyimide-epoxy is performed using direct ink writing. In another embodiment, the silane is APTMS. In another embodiment, the silane is APTES. In one embodiment, the PAA is synthesized by reacting 4,4'-oxydianiline (ODA) with pyromellitic dianhydride (PMDA). In another embodiment, the solution comprises from about 5 to about 10 weight percent of the silane. In one embodiment, the solution comprises from about 5 to about 10 weight percent of TEOS. In another embodiment, the thermosetting uses a temperature from about 80° C. to about 300° C. In one embodiment, the solution has a rheology ≥350,000 cP.

In another embodiment, the present invention is a composition for 3D printing an object. The composition includes one or more polyimide copolymers, polyimide composites or combinations thereof, the composition comprising polyamic acid (PAA), tetraethyl orthosilicate (TEOS), and a silane selected from the group consisting of aminopropyl trimethoxysilane (APTMS), aminopropyl triethoxysilane (APTES), N-[3-(trimethoxysilyl)propyl]-ethylene diamine (ETDA), and glycidoxypropyl trimethoxysilane (GPTMS). In one embodiment, the silane is APTMS. In another embodiment, the silane is APTES. In another embodiment, the composition comprises from about 5 to about 10 weight percent of the silane. In one embodiment, the composition comprises from about 5 to about 10 weight percent of TEOS. In another embodiment, the composition comprises from about 5 to about 10 weight percent of TMOS.

In another embodiment, the present invention is a 3D printed article of manufacture comprising one or more thermoset polyimide copolymers. In one embodiment, at least one of the thermoset polyimide copolymers comprises a silane selected from the group consisting of aminopropyl trimethoxysilane (APTMS), aminopropyl triethoxysilane (APTES), N-[3-(trimethoxysilyl)propyl]-ethylene diamine (ETDA), and glycidoxypropyl trimethoxysilane (GPTMS). In another embodiment, the silane is APTMS. In one embodiment, the 3D printed article comprises from about 5 to about 10 weight percent of the silane.

### BRIEF DESCRIPTION OF THE DRAWINGS

The foregoing summary, as well as the following detailed description of preferred embodiments of the application, will be better understood when read in conjunction with the appended drawings.

FIG. 1A is a flow chart showing a synthesis procedure for preparing a thermoset 5wt% APTMS PAA polyimide according to the present invention.

FIGS. 1B, 1C, and 1D are images showing various reaction schemes for preparing crosslinked copoly(amic acid) thermosetting resin.

FIG. 2A is a graph showing a FTIR comparison of PI copolymer / nanocomposite.

FIG. 2B is a graph showing FTIR peaks at 3650-3480 cm⁻¹.

FIG. 3A is a graph showing the effect of —Si—O— loading on the transition wavelength (Red shift) of the copolymers.

FIG. 3B is a graph showing the effect of —Si—O— loading on the absorbance of the copolymers.

FIG. 4 is an illustration of the basic design of a piston type direct ink writing extruder 3D printing system, demonstrating the layering of the copolymer.

FIG. 5 is a graph showing the shear viscosity of neat PAA and copolymer samples at room temperature.

FIG. 6A is an illustration showing the reaction of PDMA and ODA to form anhydride terminated PAA.

FIG. 6B is an illustration showing the reaction of PDMA and ODA to form amine terminated PAA.

FIGS. 7A-7E are chemical structures of possible different repeating units of polyimide produced using the system of the present invention.

FIG. 8A is the chemical structure of (3-Aminopropyl) trimethoxysilane (APTMS).

FIG. 8B is the chemical structure of (3-Aminopropyl) triethoxysilane (APTES).

FIG. 8C is the chemical structure of glycidoxypropyl trimethoxysilane (GPTMS).

FIG. 8D is the chemical structure of tetraethyl orthosilicate (TEOS).

FIG. 8E is the chemical structure of tetramethyl orthosilicate (TMOS).

FIG. 8F is the chemical structure of N-[3-(trimethoxysilyl)propyl]-ethylene diamine (ETDA).

FIG. 9A is an illustration of a screw type direct ink writing extruder.

FIG. 9B is an illustration of a pump type direct ink writing extruder.

FIG. 10A is a photo of a layered print depicting excellent z-strength and excellent adhesion between layers.

FIG. 10B is a graph showing the calibration curve for correlation between the number of layers and the thickness of the print.

FIG. 11A is a graph showing the dynamic mechanical properties of the thermosetting polyimide.

FIG. 11B is a graph showing dynamic tensile properties of the thermosetting polyimide. FIG. 11B shows the effect of curing temperature on the tensile properties and indicates that highest tensile modulus of ≥1 GPA, tensile strength ≥130 MPa and breaking strain of 17% were obtained at curing temperature of 250° C.

### DETAILED DESCRIPTION

One skilled in the art will recognize that the various embodiments may be practiced without one or more of the specific details described herein, or with other replacement and/or additional methods, materials, or components. In other instances, well-known structures, materials, or operations are not shown or described in detail herein to avoid obscuring aspects of various embodiments of the invention. Similarly, for purposes of explanation, specific numbers, materials, and configurations are set forth herein in order to provide a thorough understanding of the invention. Furthermore, it is understood that the various embodiments shown in the figures are illustrative representations and are not necessarily drawn to scale.

Reference throughout this specification to “one embodiment” or “an embodiment” means that a particular feature, structure, material, or characteristic described in connection with the embodiment is included in at least one embodiment of the invention, but does not denote that they are present in every embodiment. Thus, the appearances of the phrases “in an embodiment” or “in another embodiment” in various places throughout this specification are not necessarily referring to the same embodiment of the invention. Further, “a component” may be representative of one or more components and, thus, may be used herein to mean “at least one.”

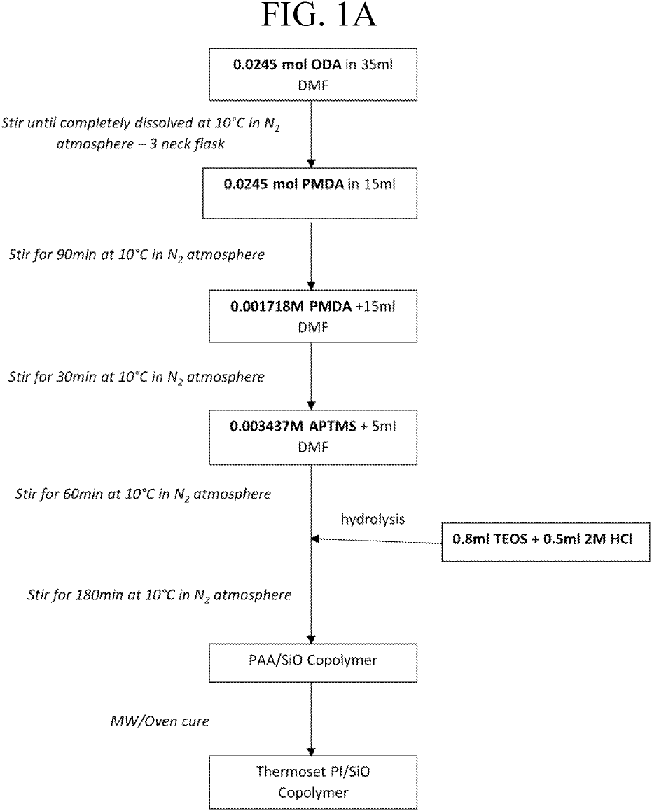

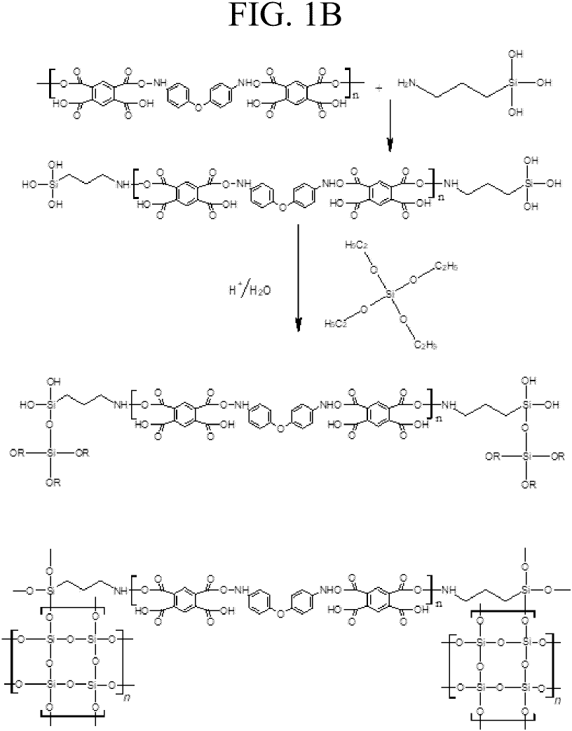

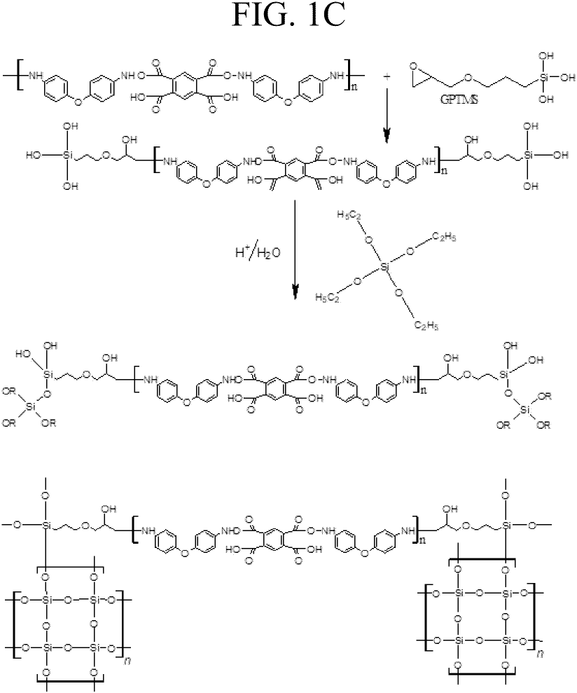

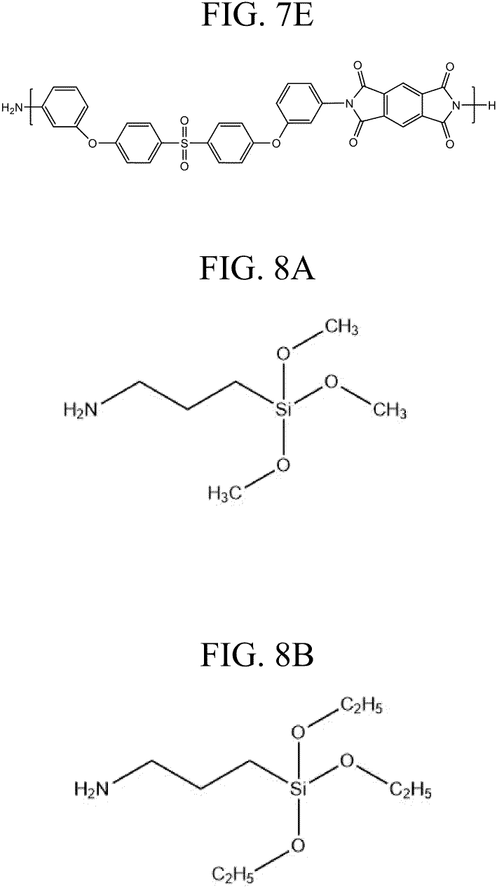

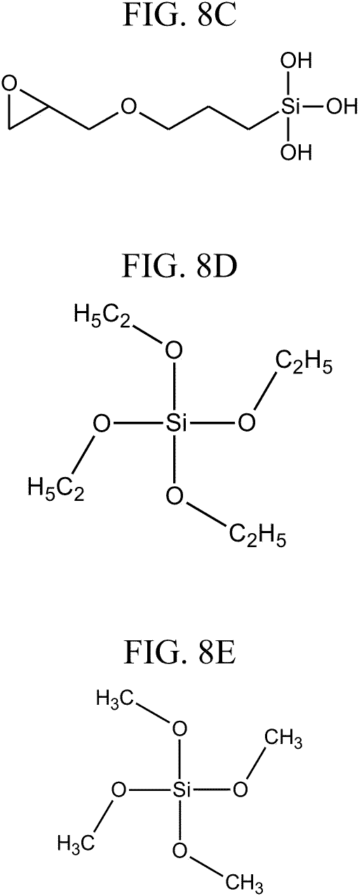

In one embodiment, the present invention involves a poly(amic acid)/siloxane hybrid crosslinked thermosetting system using either aminopropyl trimethoxysilane (APTMS), aminopropyl triethoxysilane (APTES), N-[3-(trimethoxysilyl)propyl]-ethylene diamine (ETDA), or glycidoxypropyl trimethoxysilane (GPTMS) as a coupling agent and tetraethyl orthosilicate (TEOS) or tetramethyl orthosilicate (TMOS) as a crosslinker to polymerize PAA. The synthesis flow chart and the proposed structure of the copolyimide are shown in FIGS. 1A-1D. This system significantly improves bead stability and printing accuracy. The present invention is useful for industrial application in fields where manufacturing, fabrication and development/prototyping is desired. The chemical structures for APTMS, APTES, GPTMS, and ETDA are shown in FIGS. 8A, 8B, 8C, and 8F respectively.

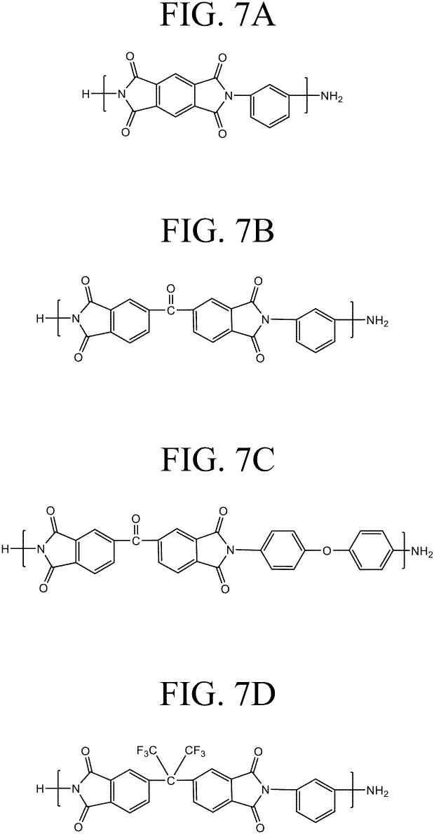

The chemical structure (extent of crosslinking) of the final product, which determines the rheological properties, depends on the organosilane (APTMS and TEOS) loading. This phenomenon can be observed in a steep shear thinning behavior in 10 wt% APTMS-PAA shear viscosity data. Incomplete condensation of APTMS and TEOS is assumed due to the steric hinderance. The rheology of the printing solution is preferably ≥ 350,000 cP. This is achieved by both copolymerization and nano reinforcement. Possible different repeating units of polyimide produced using the system of the present invention are shown in FIGS. 7A-7E.

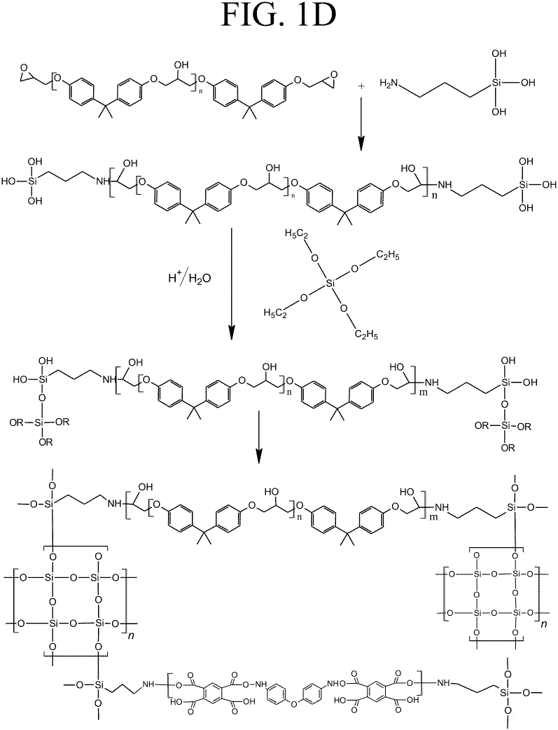

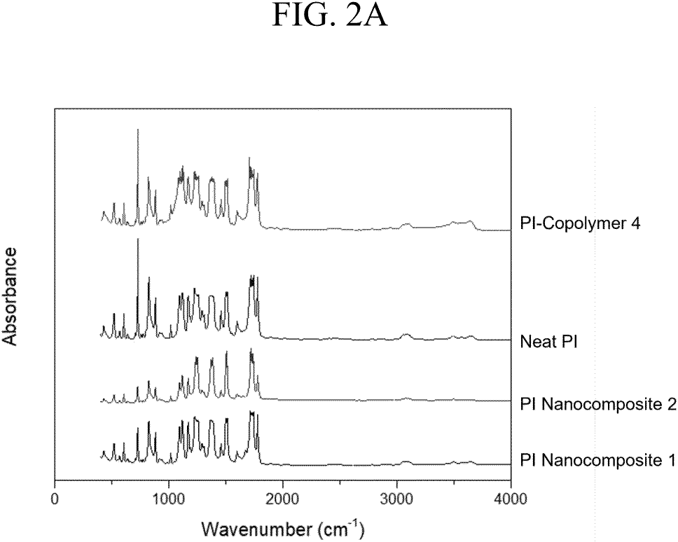

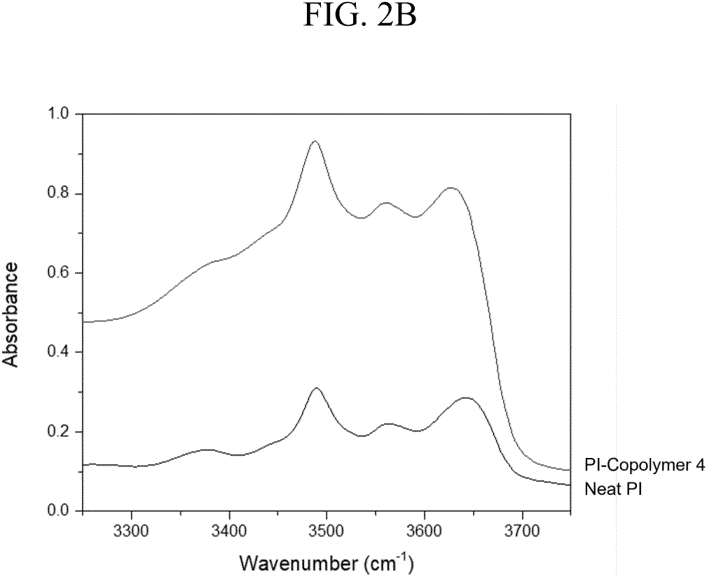

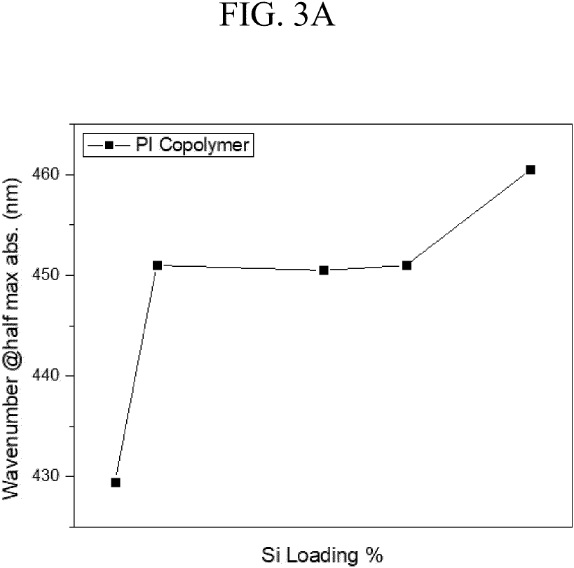

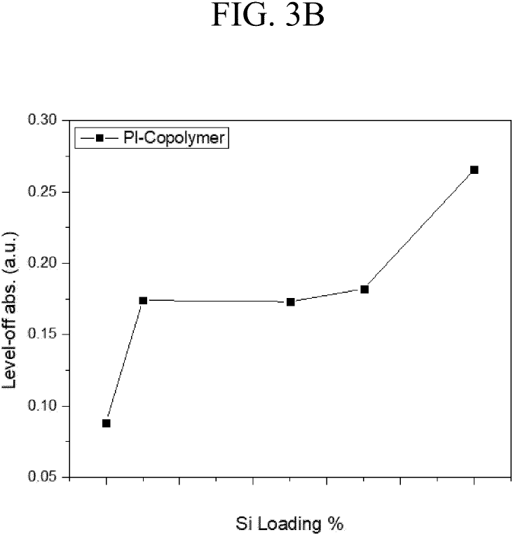

FTIR spectra of all thermally imidized PI-Si samples produced using the system of the present invention possess the characteristic imide peak at 1780 cm⁻¹ and 1380 cm⁻¹, which are associated with asymmetric C═O stretching and C—N—C stretching band, respectively, confirming successful polyimide formation (FIGS. 2A and 2B). Both the characteristic Si—O—Si absorption band at 1100 cm⁻¹ (increasing intensity with increasing Si loading) and Si(OH), free or hydrogen-bonded OH bands at 3650-3480 cm⁻¹ indicate successful incorporation of siloxane into the polyimide block. UV spectra shows both increasing red shift and absorbance with increasing siloxane loading, implying, increasing chemical crosslinking and increasing incorporation of silica —Si—O—, respectively (FIGS. 3A and 3B). TGA and DSC thermal analysis show increased char yield, decreased rate of degradation and increased Tg with increasing amount of siloxane in the thermosetting copolyimide.

The present invention can be used to make a variety of useful items, including additive manufacturing of antennas, high temperature light weight engine components for automobile, aerospace, fuselage and marine applications but not limited to structural or cosmetic components. The high thermal stability of the formulated material gives it an immense advantage of being used for high performance thermal applications.

In one embodiment of the present invention, 3D printing is done by using a modified FFF (fused filament fabrication) printer adapted for printing both solution based and solid based feed material (multi feed stock). An off-the shelf thermoplastic FFF 3D printer was modified using a fabricated adapter attachment that connected directly into the heated nozzle port via a teflon tube. The other end of the tube fed off from a resin reservoir securely attached to it. A plunger with a ratcheted track that enabled the one directional dispensing of resin was used. In one embodiment, this design can be modified to use an automated, volume-rate controllable dispenser.

An adapter unit specifically designed and modified to convert a solid FFF printer to resin printable form was fabricated. This allows the conversion of any off the shelf FFF printer to be used for this application using the same settings and software. To print thermosetting polyimide, the chemical structure and the rheology were modified by crosslinking with silicone material and nanographene/CNT filler. The printing speed ranges from 5 to 1000 mm/s. The nozzle size of 0.4 mm and above with the possibility of further scaling up, is used. Variable print speed, material dispensing, nozzle diameter, and thermal curing parameters are designed to print complex structures. In one embodiment, the general parameters for additive manufacturing of the resin copolymer included a 0.4 mm printer nozzle controlled at 30° C. and a print bed temperature of 75° C. Printing speed was set at but not limited to 50 mm/sec.

Printing parameters listed above are dependent on the type of copolymer/nanocomposite selected for printing and adjusted accordingly as desired for optimum print resolution. Computer aided designs of required components are modelled and optimized for number of layers and print parameters. This is then formatted to a gcode file for the printer to process and begin printing.

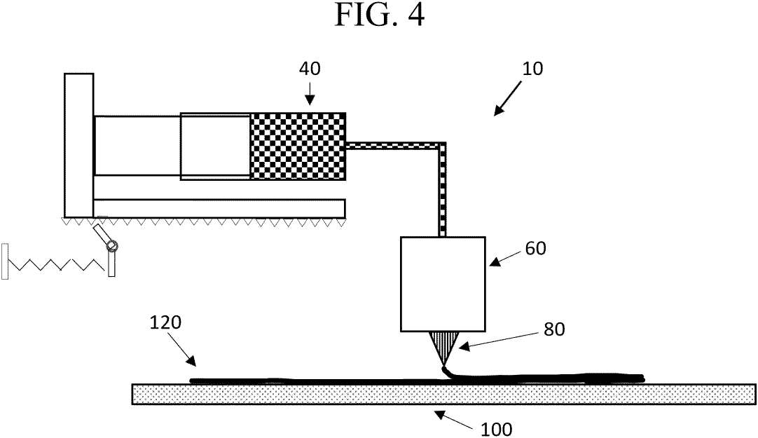

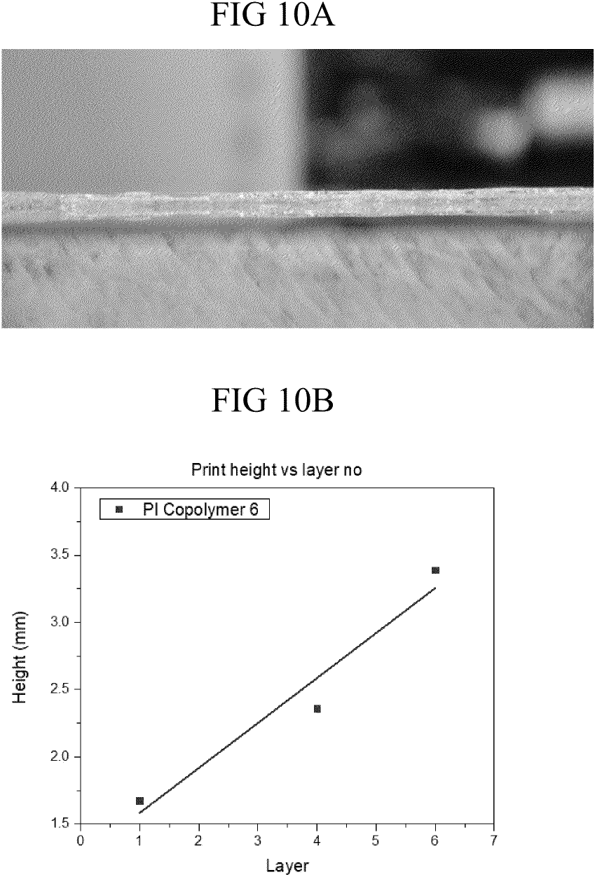

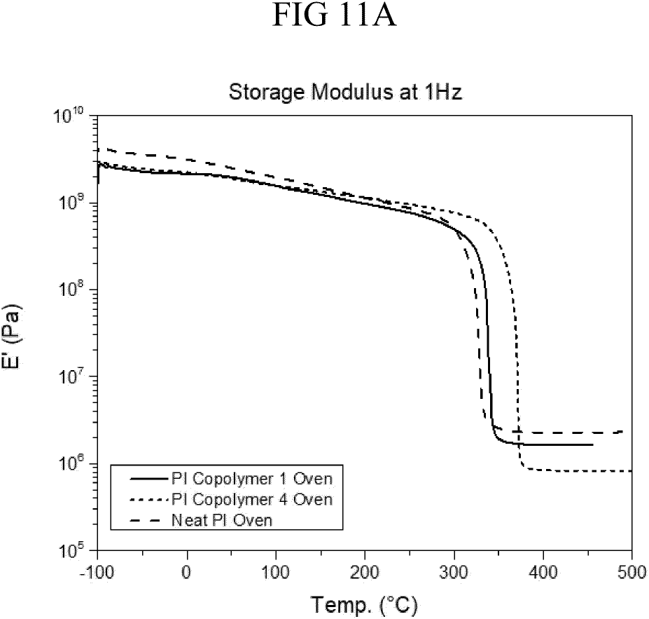

The process of additive manufacturing via 3D printing involves the layering of material from a bottom-up approach of many passes. Each layer is cured thermally via the heated print bed and forms a foundation for each layer until the desired print is complete. FIG. 4 is an illustration of the basic design of a 3D printing system, demonstrating the layering of the copolymer. Referring to FIG. 4, a printing system 10 includes a copolymer/nanocomposite reservoir 40. During printing, material from the copolymer/nanocomposite reservoir 40 flows into the 3D printer 60 and out the nose 80 to the printer bed 100. In this embodiment, the printer bed 100 is heated at a temperature of 75° C. Printed copolymer/nanocomposite bead 120 is layered on the printer bed 100. This layering creates height in the printed copolymer/nanocomposite bead 120. FIG. 10A is a photo of a layered print depicting excellent z-strength and excellent adhesion between layers. FIG. 10B is a graph showing the calibration curve for correlation between the number of layers and the thickness of the print.

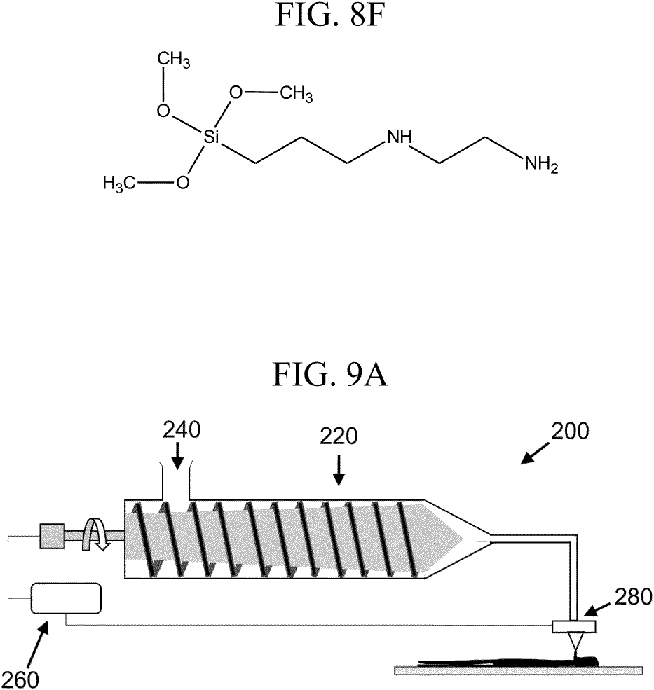

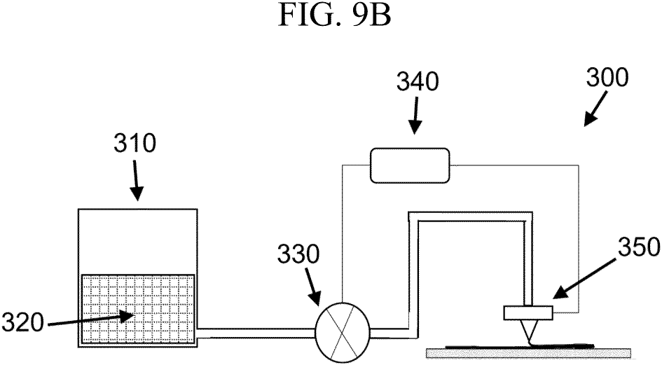

In the scaling up phase, the model described in FIG. 4 can be modified to include a larger printer with a higher capacity/volume resin tank. Print builds can be expanded to larger scale meter length components with faster print times. Wall thickness can thus be increased via a wider print bead using a larger print nozzle. This will allow larger one-piece intricate components to be manufactured which are otherwise impossible by traditional means of manufacturing. Examples of versions of the direct ink writing extruder, including the screw type direct ink writing extruder (FIG. 9A) and the pump type direct ink writing extruder (FIG. 9B) will increase printing speed and densify the print with no void. FIG. 9A is an illustration of a screw type direct ink writing extruder 200. Resin 240 is added to the extruder 220 that is controlled by a drive controller 260. The extruded resin is printed using the 3D printer 280. FIG. 9B is an illustration of a pump type direct ink writing extruder 300. An isothermal resin storage tank 310 holds resin 320. The resin 320 is propelled by a pump 330 that is controlled by a flow controller 340. The resin 320 is printed using the 3D printer 350.

### EXAMPLES

### Example 1: Synthesis of Poly(Amic Acid) (PAA)

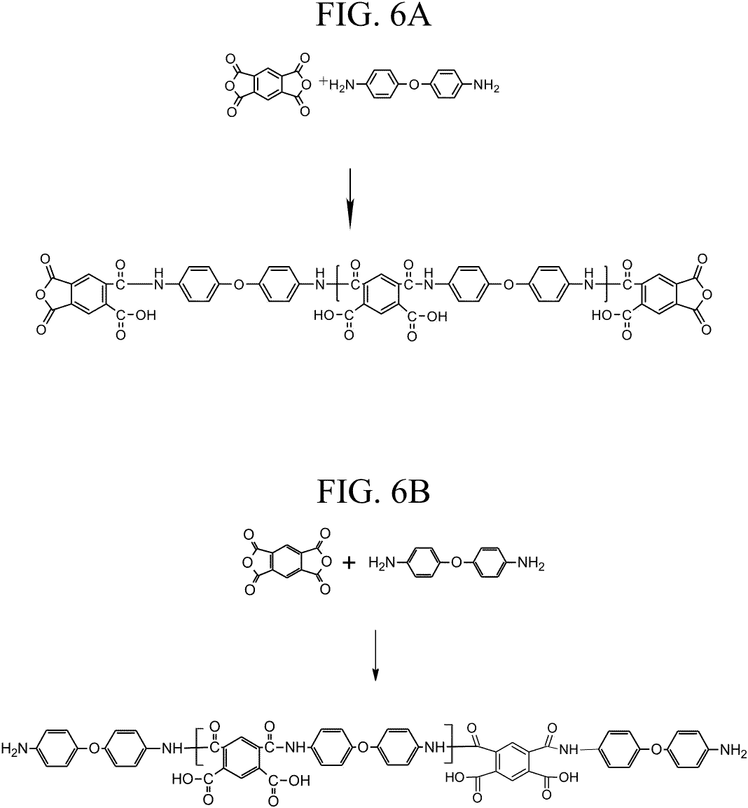

5.0060 g (0.0245 mol) of 4,4'-oxydianiline (ODA) was dissolved into 35 ml DMF (alternatively, NMP can be used) in a 3-neck-flask under nitrogen protection, and mechanically stirred until it completely dissolved at room temperature. 5.4530 g (0.0245 mol) of pyromellitic dianhydride (PMDA) and an additional 15 ml of DMF were added. This was mechanically stirred for 90 min. See FIGS. 6A and 6B.

### Example 2: Synthesis of Poly(Amic Acid)-Siloxane (PAA-Si) Thermosetting Printing

Excess 0.3825 g (0.001718 mol) PMDA was added into the reaction batch of Example 1. An additional 15 ml of DMF was added and the system was stirred for another 30 min followed by the addition of 0.6 ml (0.6162 g, 0.0034437 mol) of APTMS or APTES. Another 5 ml DMF was also added, and the system was stirred for another 2 h. Then a homogeneous solution of 0.8 ml of TEOS was hydrolyzed by adding 0.5 ml 2M HC1 into the reaction system and reacted for an additional 3 h. The whole process is operated under nitrogen atmosphere at 10° C. (See FIG. 1).

The amount of PMDA was calculated based on the amount of (3-aminopropyl) triethoxysilane (APTMS/APTES) in a molar ratio of 1:2 (equivalent moles of amino and dianhydride group). The APTMS/APTES weight percentages of 0, 1, 5, 7, 10 and 12 wt.% of PAA were studied. The amount of tetraethoxysilane (TEOS) was calculated based on equimolar amounts of the functional groups of APTMS or APTES. The amount of 2 M HC1 or acetic acid was calculated and based on an equimolar amount of Si—O functional group to water molecule.

A similar procedure was followed to prepare amine terminated poly(amic acid). However, in this case excess ODA (0.001718 mol) was used (see FIG. 6B).

### Example 3 In-Situ Synthesis of PAA-Si-CNT/NGS

0, 0.025, 0.1, 0.25, 0.5, 1, 5 wt.% of CNT and NGS, respectively, was incorporated into aPAA system by in-situ polymerization using the following steps. The calculated amount of CNT/NGS was dispersed in 50 ml DMF and sonicated for 5 h at 10° C., then ODA was added into the solution and sonicated for another 1 h. The solution was then transferred into a 3-neck-flask,following similar steps as was described in the above section (synthesis of PAA and PAA-Si-O-SiO-). In this example, 0.25 wt.% CNT was incorporated into 5 wt.% APTMS-PAA system and 5 wt.% NGS was incorporated into 7 wt.% APTMS-PAA system, respectively.

### Example 4: Rheological Study of the PAA, PAA-Si, and PAA-Si-CNT/NGS

The rheological property of PAA, PAA-Si, PAA-CNT/NGS, and PAA-Si-CNT/NGS were studied by monitoring shear viscosity of the system. A temperature and monomer concentration of 10° C. and 16-18 wt.% solid content, respectively, was used in this example. However, the effect of reaction temperature on viscosity is not remarkable, all the solution viscosities at temperature range of 10 - 60° C. lies around 900 cP at the optimum monomer concentration. Incorporation of CNT/NGS up to 5 wt.% improved solution viscosities at different percolation concentration. With the addition of only 0.1 wt.% CNT, the viscosity of the system increased up to 3000 cP while the addition of 5 wt.% NGS enhanced the viscosity up to 2500 cP. For the above mentioned PAA and PAA-CNT/NGS systems, even after carefully concentrating the solid content into relatively high loading of 40 wt.%, for improved processibility, the rheological enhancement was rather marginal in perspective of attaining successful 3D printing ink with desirable bead stability and printing accuracy. By introducing siloxane crosslinking material into the PAA system, the viscosity was remarkably increased up to 340,000 cP by the addition of a combination of 10 wt.% APTMS/APTES and equimolar amount of TEOS. The viscosity of the 5 and 7 wt.% siloxane system incorporated into PAA system exhibited a decent viscosity improvement to about 50,000 cP. Additionally, the viscosity of the printing ink was remarkably increased after the printing ink was concentrated to 40 wt.% solid content, and was successfully utilized as the 3D printing ink. The additional viscosity enhancement upon CNT/NGS incorporation into PAA-Si system is negligible.

### Example 5: Rheological and Thermal Properties of the 3D-Printing Ink

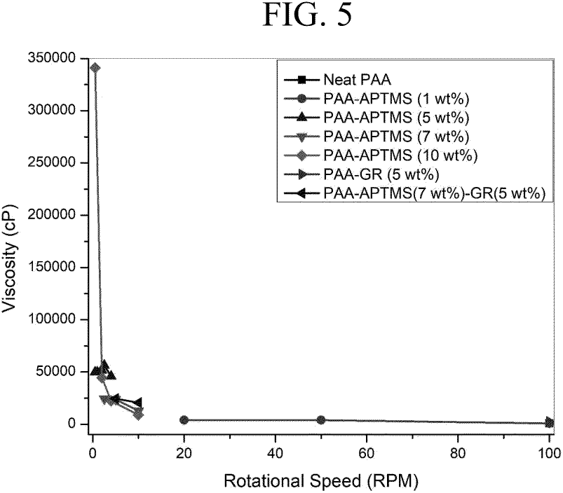

A Brookfield simple shear viscometer (LVDV-I) was used in this example to monitor the viscosity of the samples including neat polyamic acid (PAA), PAA composites (PAA-Graphene) and a thermosetting PAA precursor of the present invention. The liquid samples were tested in a cylinder linked with a constant temperature circulator. To meet the accuracy requirement, different spindle rotation rate was applied during measurement. The viscosity data is shown in FIG. 5.

Viscosity is an indicator of printability. Low viscosity samples tend to flow through the nose of the printing device but are hard to form into a stable shape. High viscosity usually supports better shape stability on printing plates. However, it might sacrifice the printing speed and efficiency. Higher viscosity also requires a bigger printing nose, which might lower the resolution of printing. For instance, neat PAA and copolymer with a low fraction of APTMS have relatively low viscosity. Those samples are not ideal for printing. Higher APTMS incorporation, on the other hand, will dramatically raise the viscosity which gives the best shape stability.

### Example 6: UV-Vis Spectroscopy and Fourier Transform Infrared Spectroscopy, FT-IR

The above techniques were applied to determinate the chemical structure of copolymers and filled copolymers prepared according to the present invention. FT-IR spectra showed the presence of the significant peaks including the imide ring, siloxanes and evidence of crosslinking. Another important piece of information from FTIR analysis is the degree of imidization (DoI). DoI is an important estimator for the amount of curing of polyimide. By comparing the DoI of the copolymer samples, it is possible to estimate the influence of the nanofillers, crosslinking density and curing conditions on the structure. UV-Vis analysis, on the other hand, focuses on the impact of crosslinking on structure due to the reaction of PAA with APTMS-TEOS or PAA with APTES-TEOS. The occurrence of red shift as a characteristic of UV-Vis absorption peaks with increased APTMS or APTES loading is indicative of increasing crosslinking density.

### Example 7: Thermal Stability and Transition Temperature

Thermal gravimetry analysis (TGA) and Differential scanning calorimeter (DSC) are commonly used thermal characterization techniques. DSC measures the glass transition temperature (Tg) as well as any other major transitions such as melting point, crystallization or chemical reactions. Tg is an important phase transition temperature which is frequently related to processing conditions such as printing nose temperature. Presence of filler or crosslinker and curing methods could strongly influence the Tg. In Table 1, the Tg of neat PI and PI-Si copolymer measured by DSC are shown.

TABLE 1

| Sample | T_{g} Oven / °C | T_{g} Microwave / °C |
|---|---|---|
| Neat PI | 363.20 | 362.83 |
| PI-APTMS (1 wt%) | 404.15 | 383.66 |
| PI-APTMS (5 wt%) | 452.25 | 378.60 |
| PI-APTMS (7 wt%) | 448.00 | 394.49 |
| PI-APTMS (10 wt%) | N/A | 362.56 |

Compared to DSC, TGA is analysis provides information about the thermal performance of the materials. Generally, TGA could measure the thermal stability of materials as shown by the char yield as well as the rate of decomposition. For instance, controlled degradation rate (height of derivation peak) was observed as a function of the amount of the crosslinker used.

### Example 8: Mechanical Properties

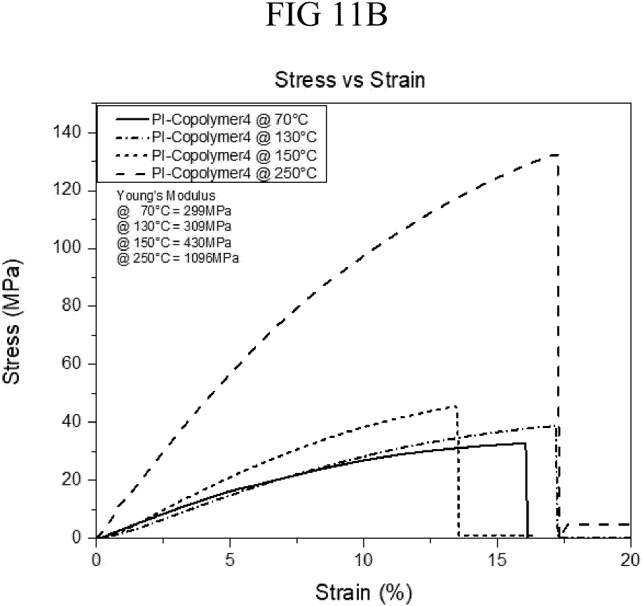

The storage modulus of the copolyimide print is compared with the neat polyimide film. It is shown the glassy region shear modulus is about 2 GPa and the glass-rubber transition temperature is ≥ 350° C., which is a remarkable performance (FIG. 11A). The tensile properties of the copolyimide increases with curing temperature. The copolyimide print cured at 250° C. has a storage modulus of ≥ 1 GPa, ultimate strength of ≥130 MPa and breaking strain of about 17% (FIG. 11B).

All documents cited are incorporated herein by reference; the citation of any document is not to be construed as an admission that it is prior art with respect to the present invention. It is to be further understood that where descriptions of various embodiments use the term “comprising,” and / or “including” those skilled in the art would understand that in some specific instances, an embodiment can be alternatively described using language “consisting essentially of” or “consisting of.”

While particular embodiments of the present invention have been illustrated and described, it would be obvious to one skilled in the art that various other changes and modifications can be made without departing from the spirit and scope of the invention. It is therefore intended to cover in the appended claims all such changes and modifications that are within the scope of this invention.

What is claimed is:

1. A method of making a three-dimensional object comprising one or more polyimide copolymers, polyimide composites or combinations thereof, the method comprising:
a. 3D printing a solution comprising polyamic acid (PAA), tetraethyl orthosilicate (TEOS), and a silane selected from the group consisting of aminopropyl trimethoxysilane (APTMS), aminopropyl triethoxysilane (APTES), N-[3-(trimethoxysilyl)propyl]-ethylene diamine (ETDA), and glycidoxypropyl trimethoxysilane (GPTMS) to produce a three-dimensional form; and
b. thermosetting the three-dimensional form.

2. The method of claim 1 wherein the 3D printing is performed using direct ink writing.

3. The method of claim 1 wherein the silane is APTMS.

4. The method of claim 1 wherein the silane is APTES.

5. The method of claim 1 wherein the PAA is synthesized by reacting 4,4'-oxydianiline (ODA) with pyromellitic dianhydride (PMDA).

6. The method of claim 1 wherein the solution comprises from about 5 to about 10 weight percent of the silane.

7. The method of claim 1 wherein the solution comprises from about 5 to about 10 weight percent of TEOS.

8. The method of claim 1 wherein the thermosetting uses a temperature from about 80° C. to about 300° C.

9. The method of claim 1 wherein the solution has a rheology ≥350,000 cP.

10. A composition for 3D printing an object comprising one or more polyimide copolymers, polyimide composites or combinations thereof, the composition comprising polyamic acid (PAA), tetraethyl orthosilicate (TEOS), and a silane selected from the group consisting of aminopropyl trimethoxysilane (APTMS) aminopropyl triethoxysilane (APTES), N-[3-(trimethoxysilyl)propyl]-ethylene diamine (ETDA), and glycidoxypropyl trimethoxysilane (GPTMS).

11. The composition of claim 10 wherein the silane is APTMS.

12. The composition of claim 10 wherein the silane is APTES.

13. The composition of claim 10 wherein the composition comprises from about 5 to about 10 weight percent of the silane.

14. The composition of claim 10 wherein the composition comprises from about 5 to about 10 weight percent of TEOS.

15. The composition of claim 10 wherein the composition comprises from about 5 to about 10 weight percent of TMOS.

16. A 3D printed article of manufacture comprising one or more thermoset polyimide copolymers.

17. The 3D printed article of claim 16 wherein at least one of the thermoset polyimide copolymers comprises a silane selected from the group consisting of aminopropyl trimethoxysilane (APTMS), aminopropyl triethoxysilane (APTES), N-[3-(trimethoxysilyl)propyl]-ethylene diamine (ETDA), and glycidoxypropyl trimethoxysilane (GPTMS).

18. The 3D printed article of claim 17 wherein the silane is APTMS.

19. The 3D printed article of claim 17 wherein the silane is APTES.

20. The 3D printed article of claim 17 wherein the 3D printed article comprises from about 5 to about 10 weight percent of the silane.
